(19) United States
(12) Patent Application Publication
(10) Pub. No.: US 2016/0087978 A1
(43) Pub. Date: Mar. 24, 2016

(54) MULTI - LAYERED BIOMETRIC SECURITY

(71) Applicant: International Business Machines Corporation, Armonk, NY (US)

(72) Inventors: Stephen Chow, Plano, TX (US); Grant Douglas Miller, Arvada, CO (US); Nader M. Nassar, Yorktown Heights, NY (US); Richard John Newhook, West Chester, PA (US); Erich Walls, Valparaiso, IN (US)

(21) Appl. No.: 14/494,107

(22) Filed: Sep. 23, 2014

(51) Int. Cl. H04L 29/06

(52) U.S. Cl. CPC H04L 63/0861

(57) ABSTRACT

A method including a computer device receiving a first authentication input from at least one user to start a multi-layered security protocol; the computer device receiving secondary authentication inputs from the at least one user to continue the multi-layered security protocol to determine if a security protocol has been met, wherein the secondary authentication inputs include receiving a first feature input from the at least one user and receiving a second feature from the at least one user; and the computer device determining if the first and secondary authentication inputs pass or fail the multi-layered security protocol.

### BACKGROUND

The present invention relates to unique inaudible sound signatures, and more specifically, to using unique inaudible sound signatures determine specific vehicle information.

### SUMMARY

According to one aspect of the present invention, a method includes a computing device receiving a first authentication input from at least one user to start a multi-layered security protocol; the computer device receiving secondary authentication inputs from the at least one user to continue the multi-layered security protocol to determine if a security protocol has been met, wherein the secondary authentication inputs include receiving a first feature input from the at least one user and receiving a second feature from the at least one user; and the computer device determining if the first and secondary authentication inputs pass or fail the multi-layered security protocol.

According to another aspect of the present invention, a system including one or more processors, one or more computer-readable memories and one or more computer-readable, tangible storage devices; a first receiving module operatively coupled to at least one of the one or more storage devices for execution by at least one of the one or more processors via at least one of the one or more memories, configured to a first authentication input from at least one user to start a multi-layered security protocol; a second receiving module operatively coupled to at least one of the one or more storage devices for execution by at least one of the one or more processors via at least one of the one or more memories, configured to receive secondary authentication inputs from the at least one user to continue the multi-layered security protocol to determine if a security protocol has been met, wherein the secondary authentication inputs include receiving a first feature input from the at least one user and receiving a second feature from the at least one user; and a determining module operatively coupled to at least one of the one or more storage devices for execution by at least one of the one or more processors via at least one of the one or more memories, configured to determine if the first and secondary authentication inputs pass or fail the multi-layered security protocol.

According to yet another aspect of the present invention, a computer program product including, one or more computer-readable, tangible storage medium; program instructions, stored on at least one of the one or more storage medium, to receive a first authentication input from at least one user to start a multi-layered security protocol; program instructions, stored on at least one of the one or more storage medium, to receive secondary authentication inputs from the at least one user to continue the multi-layered security protocol to determine if a security protocol has been met, wherein the secondary authentication inputs include receiving a first feature input from the at least one user and receiving a second feature from the at least one user; and program instructions, stored on at least one of the one or more storage medium, to determine if the first and secondary authentication inputs pass or fail the multi-layered security protocol.

### BRIEF DESCRIPTION OF THE SEVERAL VIEWS OF THE DRAWINGS

FIG. 1 shows an exemplary implementation according to an embodiment of the present invention.

FIG. 2 shows a flowchart according to an embodiment of the present invention.

FIG. 3 shows another flowchart according to an embodiment of the present invention.

FIG. 4 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

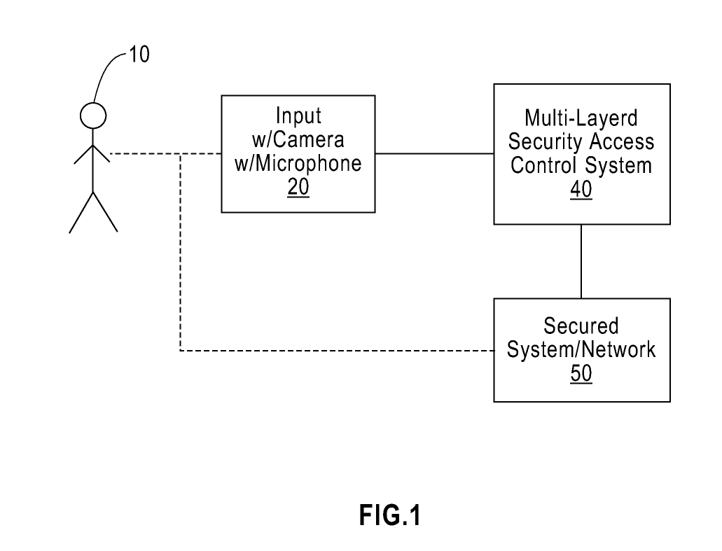

Now referring to FIG. 1, shown is an exemplary implementation according to an embodiment of the present invention showing a multi-layered security system. A user 10 requires access to a secured system or network 50 and is required to input authentication to gain access to the secured system or network 50. The user 10 is required to input passive and active authentications to gain access to the secured system or network 50. Passive authentication may include either manual passwords, ID badge having a RFID tag, or a combination of the both. Active authentication may include biometrics of the user 10. Biometrics (or biometric authentication) refers to the identification of users 10 by their characteristics or traits. An input device 20 includes manual input keys and a RFID tag reader for receiving the passive authentication input from the user 10. The input device 20 further includes a camera and microphone for capturing active authentication inputs from the user 10. The passive and authentication inputs are provided to a multi-layered security access control system 40. The multi-layered security access control system 40 uses several aspects of the active authentication inputs to determine whether the user 10 passes the security check. More details about the use of the active authentication inputs will be described in more detail hereafter.

Still referring to FIG. 1, once both the passive and active authentication inputs are supplied by the user 10, the multi-layered security access control system 40 makes a pass/fail determination for allowing the user 10 access to the secured system/network 50. The secured system/network 50 may be a personal computing device, a company's intranet, military systems or financial systems. It is further noted that the user 10 may be accessing the secured system/network 50 remotely.

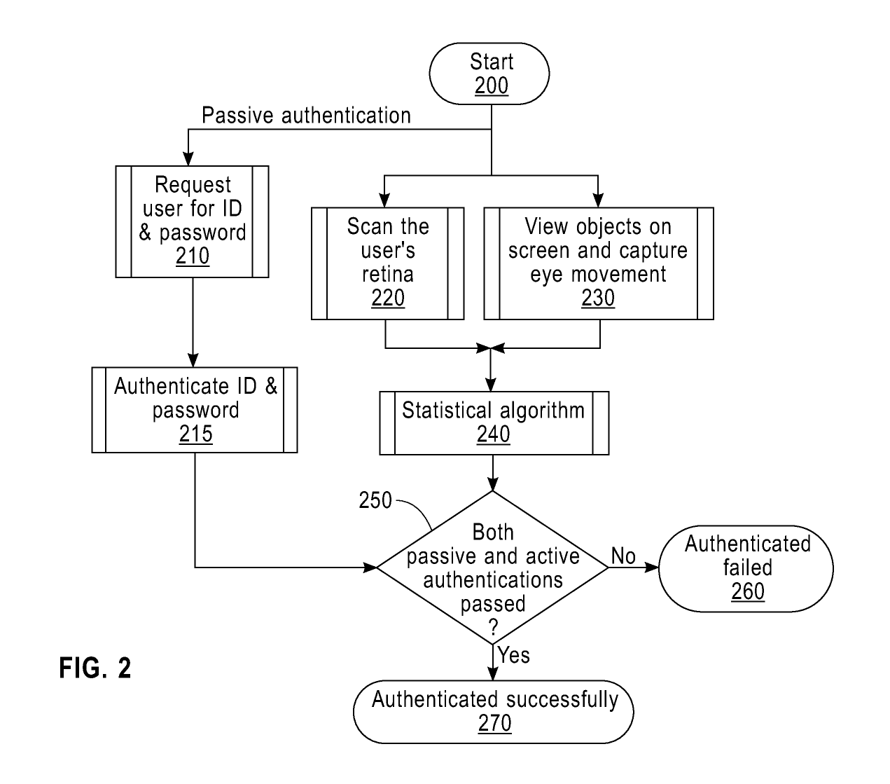

Referring to FIG. 2, a process according to an embodiment of the present invention is shown. The process starts 200 the authentication process by receiving (210) the passive authentication ID and password. The process then authenticates the ID and password (215). The process also receives active authentication inputs from a user. A first active authentication input is to scan a user's retina (220). At the same time that the first active authentication input is received, the process also receives a second active authentication input by telling the user to view objects on a screen and captures the user's eye movement (230). The eye movement would follow a predefined path, such as follow a dot. The process uses the output of the retina scan and eye movement capture to run a statistical algorithm (240) to determine if the user pass/fail the second active authentication. The algorithm determines if both the first active and second active biometric authentication inputs pass or fail. If both the first active and second active biometric authentication inputs pass, then a comparison/correlation value is determined based on the two active inputs. Both tests generate a data set that is used for the individual pass/fail test (compare against a control). Both data sets (from test X and then test Y) are used as input to the correlation function. The correlation is calculated by:

$${ρ}_{X , Y} = corr ( X , Y ) = \frac{cov ( X , Y )}{{σ}_{X} {σ}_{Y}} = \frac{E [ ( X - {μ}_{X} ) ( Y - {μ}_{Y} ) ]}{{σ}_{X} {σ}_{Y}}$$

Examples of correlation values which may determine the following actions include:
Correlation factor (0.8-1.0) strong correlation: layered authentication passed
(0.6-0.79) medium correlation: repeat test or test another layer
(0.59 or less) authentication failed.

Still referring to FIG. 2, the process determines if both the passive and active authentication inputs pass or fail (250). If both the passive and active authentication inputs pass (270), then the user is allowed access to the secured system/network. If either the passive and active authentication inputs fail (260), then the user is not allowed access to the secured system/network. The process allows for multi-layered authentication security.

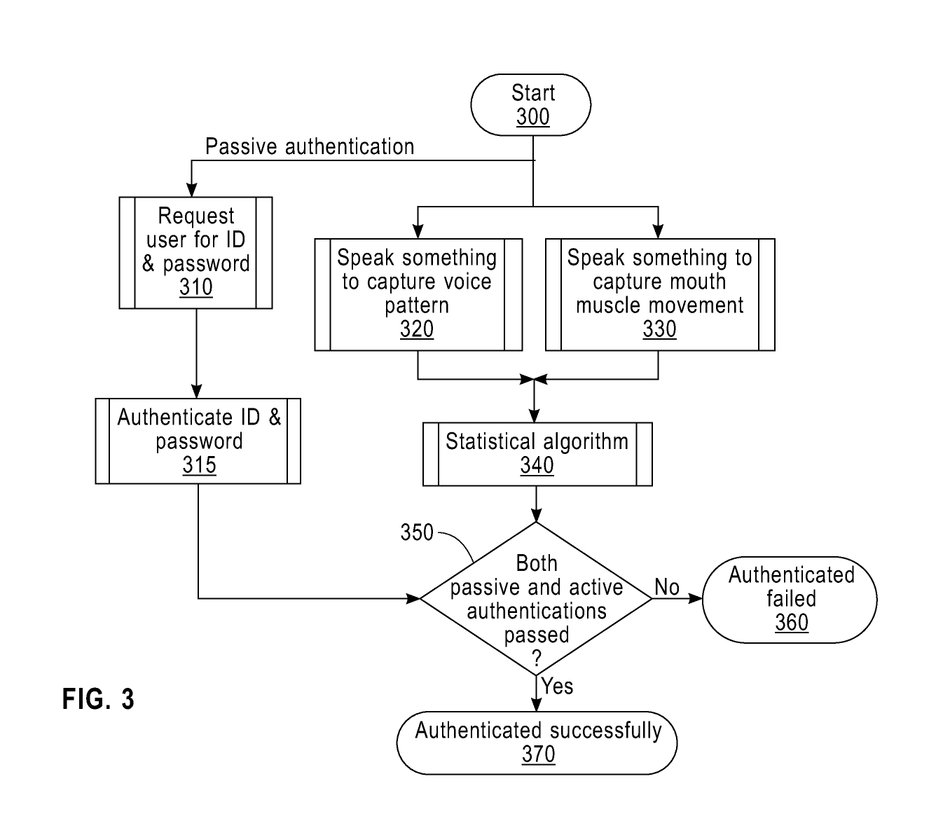

Referring to FIG. 3, a process according to an embodiment of the present invention is shown. The process starts 300 the authentication process by receiving (310) the passive authentication ID and password. The process then authenticates the ID and password (315). The process also receives active authentication inputs from a user. A first active authentication input is to capture a voice pattern from the user (320). At the same time that the first active authentication input is received, the process also receives a second active authentication input by telling the user to speak something to capture the mouth muscle movement (330). The process uses the output of the voice pattern and mouth movement capture to run a statistical algorithm (340) to determine if the user pass/fail the second active authentication. The algorithm determines if both the first active and second active biometric authentication inputs pass or fail. If both the first active and second active biometric authentication inputs pass, then a comparison/correlation value is determined based on the two active inputs. Both tests generate a data set that is used for the individual pass/fail test (compare against a control). Both data sets (from test X and then test Y) are used as input to the correlation function. The correlation is calculated by:

$${ρ}_{X , Y} = corr ( X , Y ) = \frac{cov ( X , Y )}{{σ}_{X} {σ}_{Y}} = \frac{E [ ( X - {μ}_{X} ) ( Y - {μ}_{Y} ) ]}{{σ}_{X} {σ}_{Y}}$$

Examples of correlation values which may determine the following actions include:
Correlation factor (0.8-1.0) strong correlation: layered authentication passed
(0.6-0.79) medium correlation: repeat test or test another layer
(0.59 or less) authentication failed.

Still referring to FIG. 3, the process determines if both the passive and active authentication inputs pass or fail (350). If both the passive and active authentication inputs pass (370), then the user is allowed access to the secured system/network. If either the passive and active authentication inputs fail (260), then the user is not allowed access to the secured system/network. The process allows for multi-layered authentication security.

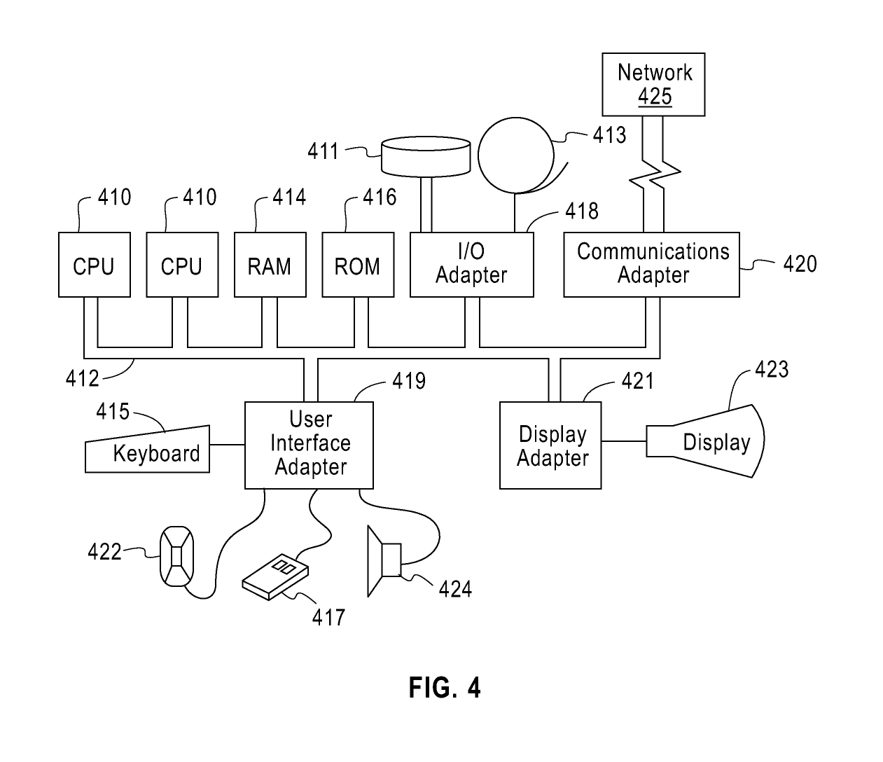

Referring now to FIG. 4, this schematic drawing illustrates a hardware configuration of an information handling/computer imaging system in accordance with the embodiments of the invention. The system comprises at least one processor or central processing unit (CPU) 410. The CPUs 410 are interconnected via system bus 412 to various devices such as a random access memory (RAM) 414, read-only memory (ROM) 416, and an input/output (I/O) adapter 418. The I/O adapter 418 can connect to peripheral devices, such as disk units 411 and tape drives 413, or other program storage devices that are readable by the system. The system can read the inventive instructions on the program storage devices and follow these instructions to execute the methodology of the embodiments of the invention. The system further includes a user interface adapter 419 that connects a keyboard 415, mouse 417, speaker 424, microphone 422, and/or other user interface devices such as a touch screen device (not shown) to the bus 412 to gather user input. Additionally, a communication adapter 420 connects the bus 412 to a data processing network 425, and a display adapter 421 connects the bus 412 to a display device 423 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computer device receiving a first authentication input from at least one user to start a multi-layered security protocol;
the computer device receiving secondary authentication inputs from the at least one user to continue the multi-layered security protocol to determine if a security protocol has been met, wherein the secondary authentication inputs include receiving a first feature input from the at least one user and receiving a second feature from the at least one user; and
the computer device determining if the first and secondary authentication inputs pass or fail the multi-layered security protocol.

2. The method according to claim 1, wherein the computer device conducts a statistical correlation between the first and second features from the at least one user to produce a correlation value.

3. The method according to claim 2, wherein the computer device uses the correlation value to determine if the at least one user passes or fail the multi-layered security protocol.

4. The method according to claim 1, wherein the first feature from the at least one user is the user's retina and the second feature from the at least one user is the user's eye movement.

5. The method according to claim 1, wherein the first feature from the at least one user is the user's voice pattern and the second feature from the at least one user is the user's mouth muscle movement.

6. The method according to claim 4, wherein the computer device conducts a statistical correlation between the first and second features from the at least one user to produce a correlation value.

7. The method according to claim 5, wherein the computer device conducts a statistical correlation between the first and second features from the at least one user to produce a correlation value.

8. A system comprising:
one or more processors, one or more computer-readable memories and one or more computer-readable, tangible storage devices;
a first receiving module operatively coupled to at least one of the one or more storage devices for execution by at least one of the one or more processors via at least one of the one or more memories, configured to a first authentication input from at least one user to start a multi-layered security protocol;
a second receiving module operatively coupled to at least one of the one or more storage devices for execution by at least one of the one or more processors via at least one of the one or more memories, configured to receive secondary authentication inputs from the at least one user to continue the multi-layered security protocol to determine if a security protocol has been met, wherein the secondary authentication inputs include receiving a first feature input from the at least one user and receiving a second feature from the at least one user; and
a determining module operatively coupled to at least one of the one or more storage devices for execution by at least one of the one or more processors via at least one of the one or more memories, configured to determine if the first and secondary authentication inputs pass or fail the multi-layered security protocol.

9. The system according to claim 8, wherein the determining module conducts a statistical correlation between the first and second features from the at least one user to produce a correlation value.

10. The system according to claim 9, wherein the determining module uses the correlation value to determine if the at least one user passes or fail the multi-layered security protocol.

11. The system according to claim 8, wherein the first feature from the at least one user is the user's retina and the second feature from the at least one user is the user's eye movement.

12. The system according to claim 8, wherein the first feature from the at least one user is the user's voice pattern and the second feature from the at least one user is the user's mouth muscle movement.

13. The system according to claim 11, wherein the determining module conducts a statistical correlation between the first and second features from the at least one user to produce a correlation value.

14. The system according to claim 12, wherein the determining module conducts a statistical correlation between the first and second features from the at least one user to produce a correlation value.

15. A computer program product comprising:
one or more computer-readable, tangible storage medium;
program instructions, stored on at least one of the one or more storage medium, to receive a first authentication input from at least one user to start a multi-layered security protocol;
program instructions, stored on at least one of the one or more storage medium, to receive secondary authentication inputs from the at least one user to continue the multi-layered security protocol to determine if a security protocol has been met, wherein the secondary authentication inputs include receiving a first feature input from the at least one user and receiving a second feature from the at least one user; and
program instructions, stored on at least one of the one or more storage medium, to determine if the first and secondary authentication inputs pass or fail the multi-layered security protocol.

16. The computer program product according to claim 15, wherein the program instructions conduct a statistical correlation between the first and second features from the at least one user to produce a correlation value.

17. The computer program product according to claim 16, wherein the program instructions use the correlation value to determine if the at least one user passes or fail the multi-layered security protocol.

18. The computer program product according to claim 15, wherein the first feature from the at least one user is the user's retina and the second feature from the at least one user is the user's eye movement.

19. The computer program product according to claim 15, wherein the first feature from the at least one user is the user's voice pattern and the second feature from the at least one user is the user's mouth muscle movement.

20. The computer program product according to claim 18, wherein the program instructions conduct a statistical correlation between the first and second features from the at least one user to produce a correlation value and use the correlation value to determine if the at least one user passes or fail the multi-layered security protocol.
